(19) United States
(12) Patent Application Publication
(10) Pub. No.: US 2010/0257188 A1
(43) Pub. Date: Oct. 7, 2010

(54) METHOD AND APPARATUS FOR PROVIDING/RECEIVING STEREOSCOPIC IMAGE DATA DOWNLOAD SERVICE IN DIGITAL BROADCASTING SYSTEM

(75) Inventors: Sun Cheul Kim, Daejeon (KR); Pyung Koo Park, Daejeon (KR); Seong Moon, Daejeon (KR); Young Soo Shin, Choongchungnam-do (KR); Ho Yong Ryu, Daejeon (KR); Sung Back Hong, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejon (KR)

(21) Appl. No.: 12/814,779

(22) Filed: Jun. 14, 2010

(30) Foreign Application Priority Data
Dec. 14, 2007 (KR) 10-2007-0131343
Jun. 15, 2009 (KR) 10-2009-0053027
Jun. 7, 2010 (KR) 10-2010-0053383

(51) Int. Cl. G06F 17/30

(52) U.S. Cl. 707/756; 707/822; 707/E17.01; 707/E17.044

(57) ABSTRACT

A method for providing a service of downloading stereoscopic image data including first image data and second image data in a digital broadcasting system includes: generating information regarding a file name of each of the first image data and the second image data; and transmitting the first image data, the information regarding the file name of the first image data, the second image data, and the information regarding the file name of the second image data. The file name of the second image data includes a prefix indicating the second image data of the stereoscopic image data.

### CROSS-REFERENCE(S) TO RELATED APPLICATIONS

The present application claims priority of Korean Patent Application Nos. 10-2009-0053027 and 10-2010-0053383, filed on Jun. 15, 2009, and Jun. 7, 2010, respectively, which are incorporated herein by reference in their entirety.

### BACKGROUND OF THE INVENTION

1. Field of the Invention

Exemplary embodiments of the present invention relate to a method and an apparatus for providing/receiving a stereoscopic image data download service in a digital broadcasting system.

2. Description of Related Art

In a satellite Digital Multimedia Broadcasting (DMB) system, users using satellite DMB terminals are provided with a still image service. Such a still image service is provided in the following manner: A satellite DMB system downloads Joint Photographic coding Experts Group (JPEG) images of 2D (monoscopic) type to a user's satellite DMB terminal through a broadcast network in advance, and provides the downloaded images in 2D type. In other words, the conventional still image service corresponds to a type of service technology for downloading at least one JPEG still image through a broadcast network in advance and displaying the 2D images to the user. For example, when the user is trying to switch channels, an advertisement or an image regarding a specific event, which has been downloaded in advance, is provided in 2D type.

Such a conventional method, which is aimed at providing users with 2D images, has a limitation in that it cannot provide stereopsis which is generally available from 3D images. If such an image service is extended and provided in 3D type, users are provided with a realistic service, which gives stereopsis comparable to real images. Such a 3D image service can make an advertisement or a specific event more noticeable.

### SUMMARY OF THE INVENTION

An embodiment of the present invention is directed to a method and an apparatus for providing/receiving a stereoscopic image data download service in a digital broadcasting system so that users are provided with a stereoscopic 3D still image service.

Another embodiment of the present invention is directed to a method and an apparatus for providing/receiving a stereoscopic image data download service in a digital broadcasting system so that a 3D still image service is provided while maintaining compatibility with existing 2D-based still image services.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a method for providing a service of downloading stereoscopic image data including first image data and second image data in a digital broadcasting system includes: generating information regarding a file name of each of the first image data and the second image data; and transmitting the first image data, the information regarding the file name of the first image data, the second image data, and the information regarding the file name of the second image data, wherein the file name of the second image data includes a prefix indicating the second image data of the stereoscopic image data.

In accordance with another embodiment of the present invention, a method for receiving a service of downloading stereoscopic image data including first image data and second image data in a digital broadcasting system includes: receiving the first image data, information regarding a file name of the first image data, the second image data, and information regarding a file name of the second image data; and mapping the first image data and the second image data based on the file name of the first image data and the file name of the second image data and reproducing a stereoscopic image, wherein the file name of the second image data includes a prefix indicating the second image data of the stereoscopic image data.

In accordance with another embodiment of the present invention, a method for providing a service of downloading stereoscopic image data including first image data and second image data in a digital broadcasting system includes: generating information regarding whether the first image data can be reproduced as a stereoscopic image or not; and transmitting the first image data, the information regarding whether the first image data can be reproduced as a stereoscopic image or not, and the second image data, wherein the information regarding whether the first image data can be reproduced as a stereoscopic image includes at least one of information regarding whether the first image data is left view image data or right view image data and identification information regarding the second image data.

In accordance with another embodiment of the present invention, a method for receiving a service of downloading stereoscopic image data including first image data and second image data in a digital broadcasting system includes: receiving the first image data, information regarding whether the first image data can be reproduced as a stereoscopic image or not, and the second image data; and mapping the first image data and the second image data based on the information regarding whether the first image data can be reproduced as a stereoscopic image and reproducing a stereoscopic image, wherein the information regarding whether the first image data can be reproduced as a stereoscopic image includes at least one of information regarding whether the first image data is left view image data or right view image data and identification information regarding the second image data.

In accordance with another embodiment of the present invention, an apparatus for providing a service of downloading stereoscopic image data including first image data and second image data in a digital broadcasting system includes: a generation unit configured to generate information regarding a file name of each of the first image data and the second image data; and a transmission unit configured to transmit the first image data, the information regarding the file name of the first image data, the second image data, and the information regarding the file name of the second image data, wherein the file name of the second image data includes a prefix indicating the second image data of the stereoscopic image data.

In accordance with another embodiment of the present invention, an apparatus for receiving a service of downloading stereoscopic image data including first image data and second image data in a digital broadcasting system includes: a reception unit configured to receive the first image data, information regarding a file name of the first image data, the second image data, and information regarding a file name of the second image data; and a reproduction unit configured to map the first image data and the second image data based on the file name of the first image data and the file name of the second image data and reproduce a stereoscopic image, wherein the file name of the second image data includes a prefix indicating the second image data of the stereoscopic image data.

In accordance with another embodiment of the present invention, an apparatus for providing a service of downloading stereoscopic image data including first image data and second image data in a digital broadcasting system includes: a generation unit configured to generate information regarding whether the first image data can be reproduced as a stereoscopic image or not; and a transmission unit configured to transmit the first image data, the information regarding whether the first image data can be reproduced as a stereoscopic image or not, and the second image data, wherein the information regarding whether the first image data can be reproduced as a stereoscopic image includes at least one of information regarding whether the first image data is left view image data or right view image data and identification information regarding the second image data.

In accordance with another embodiment of the present invention, an apparatus for receiving a service of downloading stereoscopic image data including first image data and second image data in a digital broadcasting system includes: a reception unit configured to receive the first image data, information regarding whether the first image data can be reproduced as a stereoscopic image or not, and the second image data; and a reproduction unit configured to map the first image data and the second image data based on the information regarding whether the first image data can be reproduced as a stereoscopic image and reproduce a stereoscopic image, wherein the information regarding whether the first image data can be reproduced as a stereoscopic image includes at least one of information regarding whether the first image data is left view image data or right view image data and identification information regarding the second image data.

### BRIEF DESCRIPTION OF THE DRAWINGS

FIG. 1 illustrates a stereoscopic image in accordance with the present invention.

FIG. 2 illustrates the structure of a ENDS data carousel.

FIG. 3 is a flowchart of a method for providing a stereoscopic image data download service in a digital broadcasting system in accordance with an embodiment of the present invention.

FIG. 4 is a flowchart of a method for receiving a stereoscopic image data download service in a digital broadcasting system in accordance with an embodiment of the present invention.

FIG. 5 is a flowchart of a method for providing a stereoscopic image data download service in a digital broadcasting system in accordance with another embodiment of the present invention.

FIG. 6 is a flowchart of a method for receiving a stereoscopic image data download service in a digital broadcasting system in accordance with another embodiment of the present invention.

FIG. 7 illustrates a descriptor including information regarding the file name of stereoscopic additional image data in accordance with an embodiment of the present invention.

FIG. 8 illustrates a descriptor including information regarding stereoscopic image data in accordance with an embodiment of the present invention.

FIG. 9 illustrates the construction of a digital broadcasting system in accordance with an embodiment of the present invention.

FIG. 10 illustrates a method for successive image construction to provide a still image service in accordance with an embodiment of the present invention.

FIG. 11 illustrates a method for non-successive image construction to provide a still image service in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Methods for transmitting service data in digital broadcasting systems, including satellite Digital Multimedia Broadcasting (DMB) systems, are largely divided into two types. According to the first type of methods, stream data (e.g. video) is transmitted, and according to the second type of methods, application data (e.g. web pages) is downloaded.

The first type of transmission methods (stream data transmission) are aimed at providing a real-time video service, for example, and generally transmit a coded data stream, such as a Moving Picture Experts Group Transport Stream (MPEG TS), at a constant bit rate.

The second type of transmission methods download application data (e.g. web pages), which may consist of at least one file in a directory type, and which is repeatedly transmitted to user terminals using a cyclic transmission technique (e.g. data carousel).

Such an application data service in satellite DMB is referred to as a Broadcast Network Download Service (ENDS), and actual transmission is performed using a data carousel transmission scheme based on DSM-CC (described later).

The ENDS provides functions for downloading various multimedia files (e.g. images, moving pictures) to terminals through an idle band of the Electronic Program Guide (EPG) or through a separate download service channel, receiving mail, and updating template files, which are frequently used by terminals. Digital broadcast transmission devices provide various services using the ENDS, and digital broadcasting terminals receive services transmitted through the network, process the services, and provide users with the services.

Services that can be provided using the ENDS include, for example, a channel switching scene upgrade service, an audio background scene upgrade service, a mail service, and a wake-up service.

The channel switching scene upgrade service downloads channel switching scenes, which are displayed when channels are switched, and automatically changes the scenes. The channel switching scenes may be commonly applied to all channels. Alternatively, the channel switching scenes may be applied for each service type (e.g. video service, premium video service, audio service, premium audio service) or for each channel number. The channel switching scenes may be used to provide major program notifications or event announcements.

The audio background scene upgrade service downloads and changes background scenes, which are provided when audio files are played. By upgrading audio channel background scenes, users are provided with background scenes associated with various events (e.g. program PR, advertisements). As in the case of the channel switching scenes, the audio channel background scenes can be separately set for each channel or for each service type, besides being commonly set for all audio channels.

The mail service provides public announcements, event information, and the like in a mail type. Specifically, when mail containing public announcements, event information, and the like is transmitted, the user can check the mail when connected, for example, at the channel access scene. When mail is transmitted, the terminal may receive it and display a blinking logo to inform the user that mail has arrived.

The wake-up service automatically wakes up the terminal at a time specified by a Wake-Up Table (WUT) and keeps the terminal awake for a predetermined period of time so that the terminal can download data transmitted during that time.

Hereinafter, a channel switching scene upgrade service will be described as an example of a still scene service provided using the ENDS. The channel switching scene upgrade service downloads 2D still image files (e.g. JPG files) in advance and, when the user switches channels using the terminal, the downloaded still images are displayed as background scenes during channel switching. In this case, images showing advertisements or events can be displayed.

Still image files for the channel switching scene upgrade service may, for example, consist of 12 image files, which are animated and displayed on the screen for a predetermined exposure time when channels are switched. The digital broadcast transmitting end may either transmit all of 12 images or transmit a part of them to remove redundant images and save the transmission bandwidth. In the latter case, the terminal can copy images and use them. For example, when the transmitting end transmits two channel switching scene images, the terminal copies the images according to the value of CntCopy of descriptor ImageCopyCount and uses the copies images, and the order of files follows the registration order of NameDescriptor and the file generation name rule of broadcast network download transmission specifications. When files are transmitted with redundant images removed, the terminal refers to the number included in the name of each file and internally copies vacant image ranges for use. Specifically, when only two images of CLI_{—}01.jpg and CLI_{—}07.jpg are transmitted for channel switching scenes, the terminal receives the two images and copies CLI_{—}01.jpg as CLI_{—}02.jpg to CLI_{—}06.jpg and copies CLI_{—}07.jpg as CLI_{—}08.jpg to CLI_{—}12.jpg. When transmitted files are CLI_{—}01.jpg and CLI_{—}02.jpg, the CLI_{—}01.jpg is copied as CLI_{—}03.jpg, CLI_{—}05.jpg, CLI_{—}07.jpg, CLI_{—}09.jpg, and CLI_{—}11.jpg, and CLI_{—}02.jpg is copied as CLI_{—}04.jpg, CLI_{—}06.jpg, CLI_{—}08.jpg, CLI_{—}10.jpg, and CLI_{—}12.jpg so that the two images are displayed alternately. The same copying rule can be applied when three, four, or six images are transmitted.

The terminal displays received images and, if necessary, copied image too, as channel switching scenes, as mentioned above. The channel switching scenes can be classified, according to the type of application, into common scenes for all channels, scenes for respective service types, and scenes for respective service IDs. The service types and service IDs are applied with reference to the target service, which is to be reached through channel switching, and the priority of application is: service ID>service type>common. This means that, when there are a common channel switching scene and a channel switching scene for each service type, and when the user switches channels to reach a desired service type, a channel switching scene corresponding to the desired service type, not the common channel switching scene, is applied.

Next, a case of updating channel switching scenes will be described. After receiving all channel switching scenes transmitted through the broadcast network, the terminal replaces previously stored channel switching scenes with the newly received channel switching scenes and stores the new scenes. It will be assumed for example that there are a channel switching scene corresponding to service no. 5 and a common channel switching scene. When a newly downloaded channel switching scene includes only a common channel switching scene, the channel switching scene corresponding to the service no. 5 is not used any longer, and the newly downloaded common channel switching scene is applied and used for all cases.

The present invention is directed to a method for extending a still scene service, which is currently provided through a digital broadcast network as mentioned above, and providing a stereoscopic 3D-type service.

What is basically needed to provide a 2D-based channel switching scene upgrade service in 3D type is compatibility. This means that, even when information and contents for a 3D service are transmitted, existing terminals must be able to provide a 2D-based channel switching scene upgrade service without malfunctioning.

New terminals capable of providing a 3D service must be able to provide both an existing 2D-based channel switching scene upgrade service and a 3D-based channel switching scene upgrade service. Consequently, the new terminals are supposed to provide a 3D-based channel switching scene upgrade service while guaranteeing downward and upward compatibilities.

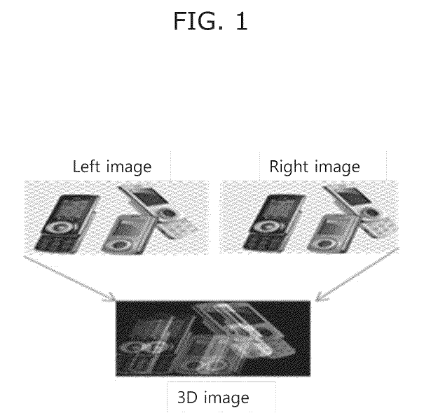

A stereoscopic image in accordance with the present invention will now be described with reference to FIG. 1.

The stereoscopic image includes a reference image and a stereoscopic additional image. The reference image refers to an image which is compatibly recognized by a conventional 2D broadcasting terminal (e.g. 2D DMB terminal) and reproduced, or which is reproduced when switching to a 2D reproduction mode. The stereoscopic additional image refers to the other image of the stereoscopic image, i.e. image of a different view. More specifically, referring to FIG. 1, when the reference image is the left view image, the stereoscopic additional image becomes the right view image, and when the reference image is the right view image, the stereoscopic additional image becomes the left view image. The user terminal subjects the reference image and the stereoscopic additional image to 3D rendering and displays the resulting stereoscopic image.

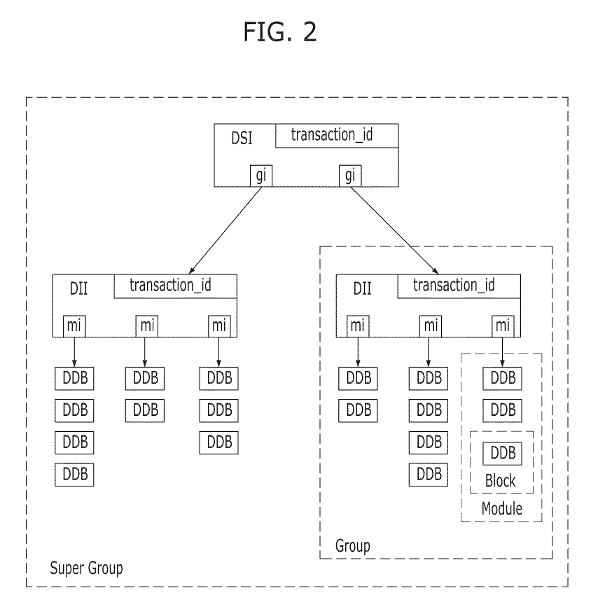

The structure of a ENDS data carousel will now be described with reference to FIG. 2.

Data for a ENDS in accordance with the present invention is transmitted based on Digital Storage Media-Command and Control (DSM-CC) data carousel specifications (ISO/IEC 13818-6[4]). According to the DSM-CC data carousel specifications, module data is repeatedly transmitted to receivers. A digital broadcast data carousel module is a logical entity regarding data within a data carousel, and consists of at least one block. Every block of every module within a data carousel has the same size except for the last block.

Digital broadcast data carousel specifications use three types of messages based on DSM-CC download specifications. Data is transmitted using a DownloadDataBlock (DDB) message, and module control information is transmitted using DownloadInfolndication (DII) and DownloadServerInitiate (DSI) messages. The DSI message contains information regarding groups within a super group, and the DII message contains information regarding modules within groups.

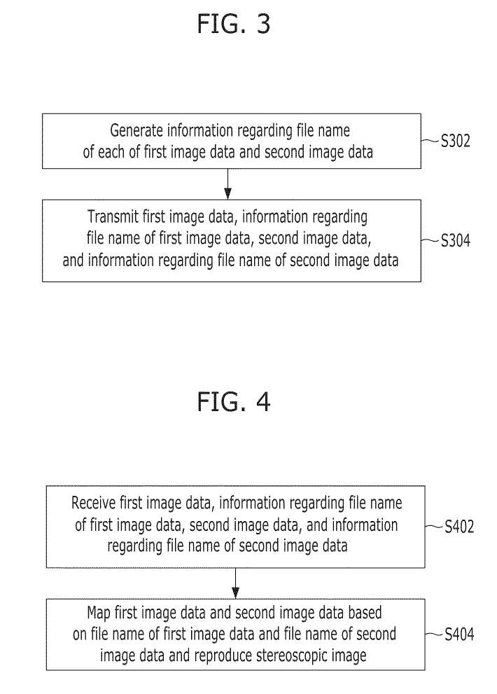

A method for providing and receiving a stereoscopic image data download service in a digital broadcasting system in accordance with an embodiment of the present invention will now be described with reference to FIGS. 3 and 4.

At step S302, the apparatus for providing a stereoscopic image data download service generates information regarding the file name of each of first image data and second image data. In accordance with an embodiment of the present invention, the first image data may be a reference image, and the second image data may be a stereoscopic additional image.

Information regarding the file name of the reference image can be generated using “name_descriptor” within DSI and DII of DSM-CC. The “name_descriptor” refers to a descriptor indicating information regarding the name of a data carousel module or a data carousel group. The structure of “name_descriptor” (refer to Table 1 below) is the same as “SAname_descriptor” (described later), and detailed description of each field will be omitted herein.

TABLE 1

| Syntax | Bit number | Type |
|---|---|---|
| name_descriptor ( ) { | | |
| descriptor_tag | 8 | uimsbf |
| descriptor_length | 8 | uimsbf |
| for (i=0; i<N; i++) { | | |
| text_char | 8 | |
| } | | |
| } | | |

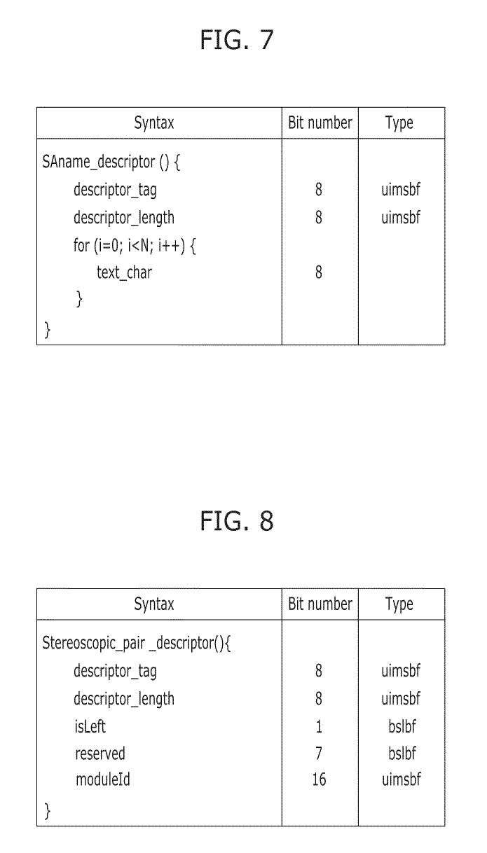

Information regarding the file name of the stereoscopic additional image is generated by defining a new descriptor (e.g. stereoscopicname_descriptor). A new descriptor including information regarding the file name of the stereoscopic additional image, in accordance with an embodiment of the present invention, can be defined as shown in FIG. 7. Referring to FIG. 7, new descriptor “SAname_descriptor” has the same structure as existing “name_descriptor”, and can be included in DII-moduleinfo and transmitted as in the case of “name_descriptor”. Specifically, descriptor_tag is an identifier indicating that descriptor SAname_descriptor is a descriptor including information regarding the file name of the stereoscopic additional image, and can be used by determining one (e.g. 0x65) of tag values defined as user private; descriptor_length indicates the length of descriptor SAname_descriptor; and text_char indicates the name (e.g. file name) of the stereoscopic additional image.

The file name of the stereoscopic additional image may include a prefix indicating that the corresponding image is a stereoscopic additional image. For example, the stereoscopic additional image may have a file name starting with “SA” (Stereoscopic Additional). When the file name of the reference image is CLI_{—}00.jpg according to the conventional file name rule, the file name of the stereoscopic additional image corresponding to the reference image (CLI_{—}00.jpg) can be SACLI_{—}00.jpg. Similarly, when the file name of the reference image is CLI_{—}01.jpg, the file name of the corresponding stereoscopic additional image can be SACLI_{—}01.jpg.

Next, at step S304, the apparatus for providing a stereoscopic image data download service transmits first image data (reference image), information regarding the file name of the first image data, second image data (stereoscopic additional image), and information regarding the file name of the second image data.

The information regarding the file name of the reference image is transmitted using conventional “name_descriptor”, and the information regarding the file name of the stereoscopic additional image is transmitted using the above-mentioned new descriptor (SAname_descriptor).

Thereafter, at step S402, the terminal receives the first image data (reference image), the information regarding the file name of the first image data, the second image data (stereoscopic additional image), and the information regarding the file name of the second image data.

The information regarding the file name of the reference image is received using conventional “name_descriptor”, and the information regarding the file name of the stereoscopic additional image is received using the above-mentioned new descriptor (“SAname_descriptor”).

Next, at step S404, the terminal maps the first image data and second image data based on the file name of the first image data (reference image) and the file name of the second image data (stereoscopic additional image), and reproduces a stereoscopic image. The terminal can acquire the reference image using “name_descriptor” and acquire the stereoscopic additional image using the new descriptor (“SAname_descriptor”).

Assuming that, according to the above-described example, reference images have file names CLI_{—}00.jpg and CLI_{—}01.jpg and stereoscopic additional images respectively corresponding to the reference images have file names SACLI_{—}00.jpg and SACLI_{—}01.jpg at the step S302, the receiving apparatus can refer to the prefix (“SA”) indicating stereoscopic additional images and determine that stereoscopic additional image SACLI_{—}00.jpg corresponds to reference image CLI_{—}00.jpg and stereoscopic additional image SACLI_{—}01.jpg corresponds to reference image CLI_{—}01.jpg. Therefore, the apparatus can map CLI_{—}00.jpg and SACLI_{—}00.jpg and reproduce a stereoscopic image, as well as map CLI_{—}01.jpg and SACLI_{—}01.jpg and reproduce another stereoscopic image. In this manner, the apparatus can map each reference image and a corresponding stereoscopic additional image and reproduce a stereoscopic image.

The terminal may follow the conventional manner of reproducing downloaded images in the ascending order, i.e. reproduce images in the ascending order with reference to the file name of reference images. For example, the terminal maps reference images CLI_{—}00.jpg, CLI_{—}01.jpg, and CLI_{—}02.jpg, in this order, with respective corresponding stereoscopic additional images SACLI_{—}00.jpg, SACLI_{—}01.jpg, and SACLI_{—}02.jpg, and reproduces stereoscopic images.

Meanwhile, 3D data needs to be identified in order to download and reproduce 3D data. To this end, “3D_service_descriptor” additionally defined within the Program Map Table (PMT) by satellite DMB stereoscopic service standards (revised version). The terminal can identify a 3D service range within broadcasting time based on “3D_service_descriptor” and acquire the corresponding service type and related information. When downloading jpg files, both left and right of which have full resolution, “contents format=0001” is used.

According to the above-described method for providing and receiving a stereoscopic image data download service, a 2D broadcasting terminal (e.g. 2D DMB terminal) can acquire and reproduce reference images using conventional “name_descriptor”. However, the 2D broadcasting terminal cannot recognize either new descriptor “SAname_descriptor” or the file name rule of stereoscopic additional image data, and ignores stereoscopic additional images without reproducing them. As such, the method for providing and receiving a stereoscopic image data download service in accordance with the present invention is compatible with conventional methods.

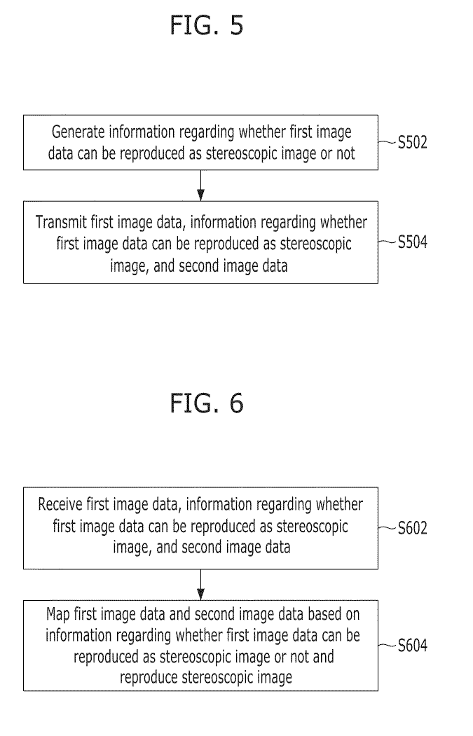

A method for providing and receiving a stereoscopic image data download service in a digital broadcasting system in accordance with another embodiment of the present invention will be described with reference to FIGS. 5 and 6.

At step S502, the apparatus for providing a stereoscopic image data download service generates information regarding whether first image data can be reproduced as a stereoscopic image or not. In accordance with an embodiment of the preset invention, as described above, the first image data may be a reference image, and the second image data may be a stereoscopic additional image.

The information regarding whether the reference image can be reproduced as a stereoscopic image or not is generated by defining a new descriptor (e.g. Stereoscopic_pair_descriptor). The new descriptor may be defined as shown in FIG. 8 in accordance with an embodiment of the present invention. The structure of “Stereoscopic_pair_descriptor” will be described in detail with reference to FIG. 8. In FIG. 8, descriptor_tag is an identifier indicating that descriptor “Stereoscopic_pair_descriptor” is a descriptor including information regarding whether the reference image can be reproduced as a stereoscopic image or not, and can be used by determining one (e.g. 0x08) of tag values defined as user private; descriptor_length indicates the length of descriptor Stereoscopic_pair_descriptor; and is Left indicates whether the corresponding image, i.e. reference image, is a left image or a right image. For example, is Left value of ‘0’ indicates a left image, and ‘1’ indicates a right image. In addition, moduleId indicates identification information regarding a stereoscopic additional image, which is to be used together with the reference image to reproduce a stereoscopic image. For example, moduleId may be the module identifier (mi, in FIG. 2) of the stereoscopic additional image.

Next, at step S504, the apparatus for providing a stereoscopic image data download service transmits first image data (reference image), information regarding whether the first image data can be reproduced as a stereoscopic image or not, and second image data (stereoscopic additional image). The information regarding whether the reference image can be reproduced as a stereoscopic image or not is transmitted using the above-described new descriptor (Stereoscopic_pair_descriptor).

The new descriptor “Stereoscopic_pair_descriptor” is included in DII-moduleinfo of a data carousel and transmitted, as shown in Table 2 below. Specifically, the new descriptor is included in the descriptor loop within DII-moduleinfo of a data carousel and transmitted.

TABLE 2

| | | | DII- | |
|---|---|---|---|---|
| | | | module | |
| Descriptor | Tag value | DII | info | Explanation |
| Type | 0x01 | | ∘ | Describes type of transmitted |
| descriptor | | | | file |
| Name | 0x02 | | ∘ | Describes name of transmitted |
| descriptor | | | | module or group |
| Module link | 0x04 | | ∘ | Indicates modules when file is |
| descriptor | | | | so large that it is divided |
| | | | | into several modules and |
| | | | | transmitted |
| Stereoscopic | 0x08 | | ∘ | Indicates that corresponding |
| pair | (reserved | | | module (file) is image that |
| descriptor | value | | | can be displayed in 3D, and |
| | assigned) | | | provides left/right image |
| | | | | information and stereoscopic |
| | | | | additional image |
| | | | | identification information |
| Compatibility | | ∘ | | Describes to specify type of |
| descriptor | | | | download target |

Next, at step S602, the terminal receives the first image data (reference image), the information regarding whether the first image data can be reproduced as a stereoscopic image or not, and the second image data (stereoscopic additional image). The information regarding whether the reference image can be reproduced as a stereoscopic image or not is received using the above-mentioned new descriptor (Stereoscopic_pair_descriptor).

Next, at step S604, the terminal maps the first image data (reference image) and the second image data (stereoscopic additional image) based on the information regarding whether the first image data can be reproduced as a stereoscopic image or not and reproduces a stereoscopic image.

The terminal can acquire a reference image and a corresponding stereoscopic additional image from each received module, i.e. image file, with reference to “Stereoscopic_pair_descriptor”. The terminal then maps the acquired reference image and stereoscopic additional image and reproduces a stereoscopic image.

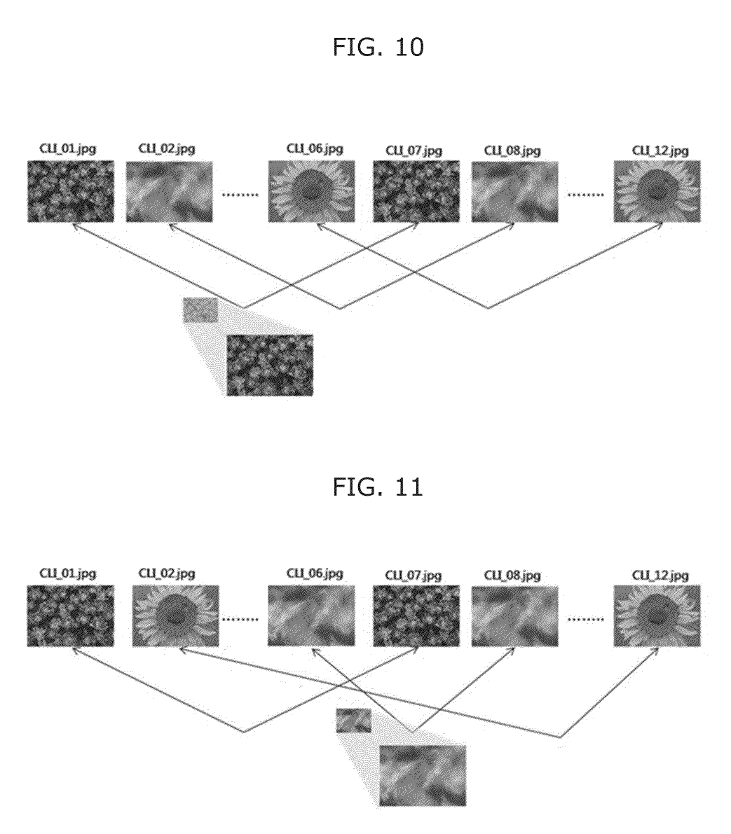

For example, when the terminal has received 12 image files, it can construct the files as shown in FIG. 10 or FIG. 11. FIG. 10 shows an example of arranging left images in the first to sixth positions and right images in the seventh to twelfth positions, and FIG. 11 shows an example of randomly arranging images.

When the terminal has received 12 images as shown in FIG. 10, it can construct table information, as shown in Table 3 below, using “Stereoscopic_pair_descriptor”.

TABLE 3

| | | | Stereoscopic |
|---|---|---|---|
| | Image distinction | | pair info: |
| Image | (left: L, right: R) | Module ID | module ID |
| CLI_01.jpg | L | 0x0001 | 0x0007 |
| CLI_02.jpg | L | 0x0002 | 0x0008 |
| CLI_03.jpg | L | 0x0003 | 0x0009 |
| CLI_04.jpg | L | 0x0004 | 0x0010 |
| CLI_05.jpg | L | 0x0005 | 0x0011 |
| CLI_06.jpg | L | 0x0006 | 0x0012 |
| CLI_07.jpg | R | 0x0007 | 0x0001 |
| CLI_08.jpg | R | 0x0008 | 0x0002 |
| CLI_09.jpg | R | 0x0009 | 0x0003 |
| CLI_10.jpg | R | 0x0010 | 0x0004 |
| CLI_11.jpg | R | 0x0011 | 0x0005 |
| CLI_12.jpg | R | 0x0012 | 0x0006 |

It is clear from Table 3 above that image no. 1 (CLI_{—}01.jpg) and image no. 7 (CLI_{—}07.jpg) constitute a pair, and image no. 2 (CLI_{—}02.jpg) and image no. 8 (CLI_{—}08.jpg) constitute a pair.

The terminal can display image no. 1 (CLI_{—}01.jpg) to image no. 12 (CLI_{—}12.jpg) successively or display arbitrary images. In this case, corresponding images can be displayed in 3D type using Table 3 above. For example, when image no. 7 (CLI_{—}07.jpg) is to be displayed, image no. 1 (CLI_{—}01.jpg), which is paired with image no. 7 (CLI_{—}07.jpg), is also used to display the image in 3D type. Similarly, when image no. 12 (CLI_{—}12.jpg) is to be displayed, image no. 6 (CLI_{—}06.jpg), which corresponds to its left image, is also used to display the image in 3D type.

When the terminal has received 12 image files as shown in FIG. 11, the image files can be displayed similarly in the above-described manner. It is to be noted, however, that “Stereoscopic_pair_descriptor” in this case informs that images nos. 1 and 7 (CLI_{—}01.jpg and CLI_{—}07.jpg), images nos. 2 and 12 (CLI_{—}02.jpg and CLI_{—}12.jpg), and images nos. 6 and 8 (CLI_{—}06.jpg and CLI_{—}08.jpg) constitute pairs, respectively.

A case of coexistence between 2D images and stereoscopic images will now be described with reference to table 4 below.

TABLE 4

| | Image distinction | | Stereoscopic |
|---|---|---|---|
| | (2D: X, left: L, | | pair info: |
| Image | right: R) | Module ID | module ID |
| CLI_01.jpg | L | 0x0001 | 0x0007 |
| CLI_02.jpg | L | 0x0002 | 0x0012 |
| CLI_03.jpg | X | 0x0003 | — |
| CLI_04.jpg | X | 0x0004 | — |
| CLI_05.jpg | X | 0x0005 | — |
| CLI_06.jpg | L | 0x0006 | 0x0008 |
| CLI_07.jpg | R | 0x0007 | 0x0001 |
| CLI_08.jpg | R | 0x0008 | 0x0006 |
| CLI_09.jpg | X | 0x0009 | — |
| CLI_10.jpg | X | 0x0010 | — |
| CLI_11.jpg | X | 0x0011 | — |
| CLI_12.jpg | R | 0x0012 | 0x0002 |

Referring to Table 4 above, CLI_{—}03.jpg, CLI_{—}04.jpg, CLI_{—}05.jpg, CLI_{—}09.jpg, CLI_{—}10.jpg, and CLI_{—}11.jpg are images that can only be displayed in 2D type, and have no stereoscopic additional image information based on “Stereoscopic_pair_descriptor”. The remaining images can constitute pairs of reference images and stereoscopic additional images, which can be displayed in 3D type, and have stereoscopic additional image information based on “Stereoscopic_pair_descriptor”. Therefore, the terminal can construct table information as shown in Table 4 above using “Stereoscopic_pair_descriptor”.

Therefore, 2D images are displayed in 2D type, and left or right images that can only be reproduced as stereoscopic images (3D images) are used to display 3D images. In other words, when image files downloaded as shown in Table 4 are to be displayed on the screen during channel switching, an existing 2D broadcasting terminal (e.g. 2D DMB terminal) can display images regardless of stereoscopic information (3D information) such as “Stereoscopic_pair_descriptor”. In the case of a 3D broadcasting terminal (e.g. 3D DMB terminal), when the user wants to watch in 2D mode, corresponding images are displayed in 2D type. When the user wants to watch in 3D mode, 2D images are displayed in 2D type, and 3D images are displayed in 3D type additionally using corresponding stereoscopic additional images (right images when left images are reference images; left images when right images are reference images).

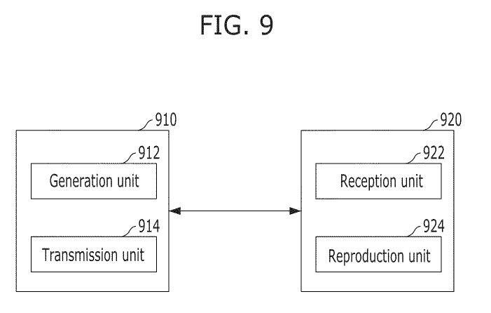

FIG. 9 illustrates the construction of a digital broadcasting system in accordance with an embodiment of the present invention. Referring to FIG. 9, the digital broadcasting system includes an apparatus 910 for providing a stereoscopic image data download service and an apparatus 920 for receiving the stereoscopic image data download service.

The apparatus 910 for providing a stereoscopic image data download service is configured to provide a stereoscopic image data download service, and includes a generation unit 912 and a transmission unit 914.

When a stereoscopic image data download service is provided according to the method illustrated in FIGS. 3 and 4, the generation unit 912 generates information regarding the file name of each of first image data and second image data, as has been described in detail at step S302 of FIG. 3. The transmission unit 914 transmits the first image data, the information regarding the file name of the first image data, the second image data, and the information regarding the file name of the second image data, as has been described in detail at step S304 of FIG. 3.

When a stereoscopic image data download service is provided according to the method shown in FIGS. 5 and 6, the generation unit 912 generates information regarding whether first image data can be reproduced as an stereoscopic image or not, as has been described in detail at step S502 of FIG. 5. The transmission unit 914 transmits the first image data, the information regarding whether the first image data can be reproduced as a stereoscopic image or not, and the second image data, as has been described in detail at step S504 of FIG. 5.

The apparatus 920 for receiving a stereoscopic image data download service is configured to receive a stereoscopic image download service, and may be a user terminal, for example. The apparatus 920 includes a reception unit 922 and a reproduction unit 924.

When a stereoscopic image data download service is received according to the method illustrated in FIGS. 3 and 4, the reception unit 922 receives first image data, information regarding the file name of the first image data, second image data, and information regarding the file name of the second image data, as has been described in detail at step S402 of FIG. 4. The reproduction unit 924 maps the first image data and second image data based on the file name of the first image data and the file name of the second image data and reproduces a stereoscopic image, as has been described in detail at step S404 of FIG. 4.

When a stereoscopic image data download service is received according to the method illustrated in FIGS. 5 and 6, the reception unit 922 receives first image data, information regarding whether the first image data can be reproduced as a stereoscopic image or not, and second image data, as has been described in detail at step S602 of FIG. 6. The reproduction unit 924 maps the first image data and second image data based on the information regarding whether the first image data can be reproduced as a stereoscopic image or not and reproduces a stereoscopic image, as has been described in detail at step S604 of FIG. 6.

The above-described methods for providing a 3D still image service are not limited to the channel switching scene upgrade service, which has been described only as an example, but are applicable to various services capable of providing 3D still image services through a digital broadcast network.

In accordance with the exemplary embodiments of the present invention, users are provided with a more realistic 3D still image service, including 3D-type advertisements and specific events.

Furthermore, a 3D still image service can be provided through a digital broadcast network while maintaining compatibility with existing 2D-based still image services. Such compatibility with existing terminals makes it possible to additionally provide a 3D still image service without changing existing terminals.

The above-described methods can also be embodied as computer programs. Codes and code segments constituting the programs may be easily construed by computer programmers skilled in the art to which the invention pertains. Furthermore, the created programs may be stored in computer-readable recording media or data storage media and may be read out and executed by the computers. Examples of the computer-readable recording media include any computer-readable recoding media, e.g., intangible media such as carrier waves, as well as tangible media such as CD or DVD.

While the present invention has been described with respect to the specific embodiments, it will be apparent to those skilled in the art that various changes and modifications may be made without departing from the spirit and scope of the invention as defined in the following claims.

What is claimed is:

1. A method for providing a service of downloading stereoscopic image data comprising first image data and second image data in a digital broadcasting system, comprising:
generating information regarding a file name of each of the first image data and the second image data; and
transmitting the first image data, the information regarding the file name of the first image data, the second image data, and the information regarding the file name of the second image data, wherein
the file name of the second image data comprises a prefix indicating the second image data of the stereoscopic image data.

2. The method of claim 1, wherein the second image data has a view different from the first image data.

3. The method of claim 1, wherein the information regarding the file name of the first image data is contained in Name_descriptor, and the information regarding the file name of the second image data is contained in a descriptor (StereoscopicName_descriptor) defined to have a structure identical to a structure of the Name_descriptor.

4. The method of claim 1, wherein the file name of the second image data comprises the file name of the first image data corresponding to the second image data and the prefix.

5. A method for receiving a service of downloading stereoscopic image data comprising first image data and second image data in a digital broadcasting system, comprising:
receiving the first image data, information regarding a file name of the first image data, the second image data, and information regarding a file name of the second image data; and
mapping the first image data and the second image data based on the file name of the first image data and the file name of the second image data and reproducing a stereoscopic image, wherein
the file name of the second image data comprises a prefix indicating the second image data of the stereoscopic image data.

6. The method of claim 5, wherein the second image data has a view different from the first image data.

7. The method of claim 5, wherein the information regarding the file name of the first image data is contained in Name_descriptor, and the information regarding the file name of the second image data is contained in a descriptor (StereoscopicName_descriptor) defined to have a structure identical to a structure of the Name_descriptor.

8. The method of claim 5, wherein the file name of the second image data comprises the file name of the first image data corresponding to the second image data and the prefix.

9. A method for providing a service of downloading stereoscopic image data comprising first image data and second image data in a digital broadcasting system, comprising:
generating information regarding whether the first image data can be reproduced as a stereoscopic image or not; and
transmitting the first image data, the information regarding whether the first image data can be reproduced as a stereoscopic image or not, and the second image data, wherein
the information regarding whether the first image data can be reproduced as a stereoscopic image comprises at least one of information regarding whether the first image data is left view image data or right view image data and identification information regarding the second image data.

10. The method of claim 9, wherein the information regarding whether the first image data can be reproduced as a stereoscopic image is contained in Stereoscopic_pair_descriptor,
the Stereoscopic_pair_descriptor comprises an identifier of the Stereoscopic_pair_descriptor, a length of the Stereoscopic_pair_descriptor, the information regarding whether the first image data is left view image data or right view image data, and the identification information regarding the second image data, and
the identification information regarding the second image data is an ID of a module comprising the second image data.

11. A method for receiving a service of downloading stereoscopic image data comprising first image data and second image data in a digital broadcasting system, comprising:
receiving the first image data, information regarding whether the first image data can be reproduced as a stereoscopic image or not, and the second image data; and
mapping the first image data and the second image data based on the information regarding whether the first image data can be reproduced as a stereoscopic image and reproducing a stereoscopic image, wherein
the information regarding whether the first image data can be reproduced as a stereoscopic image comprises at least one of information regarding whether the first image data is left view image data or right view image data and identification information regarding the second image data.

12. The method of claim 11, wherein the information regarding whether the first image data can be reproduced as a stereoscopic image is contained in Stereoscopic_pair_descriptor,
the Stereoscopic_pair_descriptor comprises an identifier of the Stereoscopic_pair_descriptor, a length of the Stereoscopic_pair_descriptor, the information regarding whether the first image data is left view image data or right view image data, and the identification information regarding the second image data, and
the identification information regarding the second image data is an ID of a module comprising the second image data.

13. An apparatus for providing a service of downloading stereoscopic image data comprising first image data and second image data in a digital broadcasting system, comprising:
a generation unit configured to generate information regarding a file name of each of the first image data and the second image data; and
a transmission unit configured to transmit the first image data, the information regarding the file name of the first image data, the second image data, and the information regarding the file name of the second image data, wherein
the file name of the second image data comprises a prefix indicating the second image data of the stereoscopic image data.

14. The apparatus of claim 13, wherein the information regarding the file name of the first image data is contained in Name_descriptor, and the information regarding the file name of the second image data is contained in a descriptor (StereoscopicName_descriptor) defined to have a structure identical to a structure of the Name_descriptor.

15. An apparatus for receiving a service of downloading stereoscopic image data comprising first image data and second image data in a digital broadcasting system, comprising:
a reception unit configured to receive the first image data, information regarding a file name of the first image data, the second image data, and information regarding a file name of the second image data; and
a reproduction unit configured to map the first image data and the second image data based on the file name of the first image data and the file name of the second image data and reproduce a stereoscopic image, wherein
the file name of the second image data comprises a prefix indicating the second image data of the stereoscopic image data.

16. The apparatus of claim 15, wherein the information regarding the file name of the first image data is contained in Name_descriptor, and the information regarding the file name of the second image data is contained in a descriptor (StereoscopicName_descriptor) defined to have a structure identical to a structure of the Name_descriptor.

17. An apparatus for providing a service of downloading stereoscopic image data comprising first image data and second image data in a digital broadcasting system, comprising:
a generation unit configured to generate information regarding whether the first image data can be reproduced as a stereoscopic image or not; and
a transmission unit configured to transmit the first image data, the information regarding whether the first image data can be reproduced as a stereoscopic image or not, and the second image data, wherein
the information regarding whether the first image data can be reproduced as a stereoscopic image comprises at least one of information regarding whether the first image data is left view image data or right view image data and identification information regarding the second image data.

18. The apparatus of claim 17, wherein the information regarding whether the first image data can be reproduced as a stereoscopic image is contained in Stereoscopic_pair_descriptor,
the Stereoscopic_pair_descriptor comprises an identifier of the Stereoscopic_pair_descriptor, a length of the Stereoscopic_pair_descriptor, the information regarding whether the first image data is left view image data or right view image data, and the identification information regarding the second image data, and
the identification information regarding the second image data is an ID of a module comprising the second image data.

19. An apparatus for receiving a service of downloading stereoscopic image data comprising first image data and second image data in a digital broadcasting system, comprising:
a reception unit configured to receive the first image data, information regarding whether the first image data can be reproduced as a stereoscopic image or not, and the second image data; and
a reproduction unit configured to map the first image data and the second image data based on the information regarding whether the first image data can be reproduced as a stereoscopic image and reproduce a stereoscopic image, wherein
the information regarding whether the first image data can be reproduced as a stereoscopic image comprises at least one of information regarding whether the first image data is left view image data or right view image data and identification information regarding the second image data.

20. The apparatus of claim 19, wherein the information regarding whether the first image data can be reproduced as a stereoscopic image is contained in Stereoscopic_pair_descriptor,
the Stereoscopic_pair_descriptor comprises an identifier of the Stereoscopic_pair_descriptor, a length of the Stereoscopic_pair_descriptor, the information regarding whether the first image data is left view image data or right view image data, and the identification information regarding the second image data, and
the identification information regarding the second image data is an ID of a module comprising the second image data.
